(19) United States
(12) Patent Application Publication
(10) Pub. No.: US 2017/0054304 A1
(43) Pub. Date: Feb. 23, 2017

(54) Mechanical Battery Ramp

(71) Applicant: Mattel, Inc., El Segundo, CA (US)

(72) Inventors: David Wong, New York, NY (US); Thomas Crimmins, Staten Island, NY (US)

(21) Appl. No.: 14/827,586

(22) Filed: Aug. 17, 2015

(51) Int. Cl. H02J 7/00

(52) U.S. Cl. CPC H02J 7/0019; H02J 7/0045

(57) ABSTRACT

An improved battery assembly is disclosed herein. The battery assembly includes a housing configured to receive at least one battery, at least one positive contact, at least one negative contact, and a switch member movably coupled to housing. The at least one negative contact may contains a resilient member configured to bias the at least one battery into abutment with the at least one positive contact. The switch member may include a protrusion. The switch member may also be movable between a first position and a second position, where moving the switch member to the second position causes the protrusion to protrude into the housing proximate to the at least one positive contact. The protrusion protruding into the housing urges the at least one battery out of abutment with the at least one positive contact, and stops the output of power from the battery assembly.

### FIELD OF THE INVENTION

The present invention relates to a mechanical power switch for devices powered by batteries. More specifically, the invention provides mechanical switch that closes and opens a circuit to turn a device on and off.

### BACKGROUND OF THE INVENTION

Current battery assemblies of devices often include a battery box, or other structure, to house at least one battery. Battery assemblies further include an electro-mechanical switch that is coupled to a printed circuit board via a set of wires. The combination of the electro-mechanical switch and the printed circuit board may be configured to control any power sent from the at least one battery to the various electrical components (light output component, audible output component, electrical motor, etc.) of the device. The at least one battery forms a circuit with the printed circuit board, so that when the circuit is closed, the components are powered by the at least one battery. Moreover, operation of the electro-mechanical switch between an “on” position and an “off” position results in the circuit being opened and closed via the printed circuit board, and thus the components being unpowered or powered. Current battery assemblies further include a “glamour cap” that is configured to sit atop and cover the electro-mechanical switch. The glamour cap of the battery assembly extends out of the battery assembly to be operated by a user of the device. As the glamour cap is moved to an “on” position, the electro-mechanical switch coupled to printed circuit board is also moved to the “on” position. Similarly, as the glamour cap is moved to an “off” position, the electro-mechanical switch coupled to printed circuit board is also moved to the “off” position. Thus, operation of the glamour cap results in operation of the device.

The costs that are associated with designing, manufacturing, and assembling the electro-mechanical switch, printed circuit board, and wires of current battery assemblies for devices get passed onto the end user of the device. Moreover, having multiple components for controlling the on and off functions of a device provides the ability for each one of these components to fail, resulting in an inoperable device.

It would be desirable to provide an electronic device that contains a simple mechanism for turning the electronic device on and off. Moreover, it would be desirable to provide an electronic device that costs less to manufacture and assemble.

### SUMMARY OF THE INVENTION

An improved battery assembly according to the present invention includes a housing, at least one positive contact, at least one negative contact, and a switch member. The housing includes a channel that contains a first end, a second end, and an opening disposed proximate to the first end. The channel of the housing may be sized and shaped to receive at least one battery. The at least one positive contact may be disposed proximate to the first end of the channel, while the at least one negative contact may be disposed proximate to the second end of the channel. Moreover, in the depicted embodiment, the at least one negative contact contains a resilient member that may be configured to bias the at least one battery towards the at least one positive contact so that the at least one battery abuts the at least one positive contact.

The switch member of the battery assembly may include a protrusion. Moreover, the switch member may be movably coupled to the housing, where the switch member may be positioned in a first position and a second position. When the switch member is in the second position, the protrusion of the switch member may be configured to protrude through the opening in the channel of the housing proximate to the at least one positive contact. When at least one battery is disposed within the channel of the housing and the switch member is in the second position, the protrusion of the switch member may contact the at least one battery to urge the at least one battery away from the at least one positive contact. Thus, when the switch member is in the second position, the at least one battery is separated from the at least one positive contact (preventing a closed circuit).

Another embodiment of the battery assembly according to the present invention includes a housing, at least one positive contact, at least one negative contact, and a switch member pivotally coupled to the housing. The housing may include a first and a second end, and may be configured to receive at least one battery. The switch member may include a first and a second end, and may be configured to pivot between a first position and a second position. When the switch member is pivoted into the second position, the second end of the switch member may extend into the housing proximate to the at least one positive contact. When the second end of the switch member extends into the housing, the second end of the switch member may separate the at least one battery from the at least one positive contact (preventing a closed circuit).

According to this embodiment, the switch member may include an elongate portion, a curved portion, and a wedge portion. Moreover, the housing may include a first portion and a second portion, where the switch member may be coupled to the first portion, and the second portion may be configured to receive the at least one battery. The housing may further include a partition that separates the first portion from the second portion. However, the curved portion of the switch member may be configured to curve around the partition when the switch member is in the second position, which urges the wedge portion of the switch member to extend into the second portion of the housing proximate to the at least one positive contact.

In yet another embodiment of the battery assembly according to the present invention includes a housing configured to receive at least one battery, at least one positive contact, at least one negative contact, and a switch member slidably coupled to the housing. The housing may include a first end and a second end, where the at least one positive contact may be disposed proximate to the first end and the at least one negative contact may be disposed proximate to the second end. The at least one negative contact may contain a resilient member configured to bias the at least one battery into abutment with the at least one positive contact.

Moreover, the switch member of this embodiment of the battery assembly may have a first end and a second end. As previously explained, the switch member may be slidably coupled to the housing, where the switch member may be configured to slide between a first position and a second position, wherein sliding the switch member into the second position urges the second end of the switch element to at least partially extend into the housing proximate to the at least one positive contact. When the second end of the switch member is extending into the housing, the second end of the switch member may be separating the at least one battery from the at least one positive contact (preventing a closed circuit).

This embodiment of the battery assembly may be configured to house three batteries, where the housing contains a first channel, a second channel, and a third channel. Each one of the channels may include a positive contact and a negative contact, where the batteries received in the first, second, and third channels are connected in series. Furthermore, the housing may further contain an opening disposed in the first channel proximate to the positive contact disposed in the first channel. When the switch member is slid into the second position, the second end of the switch member may be configured to extend into the first channel proximate to the first positive contact to separate the battery received in the first channel from the first positive contact (preventing a closed circuit).

Although the phrases “positive contact” and “negative contact” are used throughout this disclosure, the invention disclosed herein may be applied to either the positive contact or the negative contact without departing from the scope and spirit of the invention.

### BRIEF DESCRIPTION OF THE DRAWINGS

FIG. 1 illustrates a front view of an embodiment of a battery assembly that includes a mechanical switch according to the present invention, the mechanical switch being positioned in the “on” position.

FIG. 2 illustrates a front view of the embodiment of the battery assembly illustrated in FIG. 1, the mechanical switch being positioned in the “off” position.

FIG. 3 illustrates a rear view of the embodiment of the battery assembly illustrated in FIG. 1.

FIG. 4A illustrates a perspective view of the front of the battery box of the embodiment of the battery assembly illustrated in FIG. 1.

FIG. 4B illustrates a perspective view of the rear of the embodiment of the battery box illustrated in FIG. 4A.

FIG. 5 illustrates a perspective view of the switch member of the embodiment of the battery assembly illustrated in FIG. 1.

FIG. 6A illustrates a perspective view of the top of a battery of the embodiment of the battery assembly illustrated in FIG. 1.

FIG. 6B illustrates a perspective view of the bottom of the battery of illustrated in FIG. 6A.

FIG. 7 illustrates a perspective view of a positive contact of the embodiment of the battery assembly illustrated in FIG. 1.

FIG. 8 illustrates a perspective view of the negative contact of the embodiment of the battery assembly illustrated in FIG. 1.

FIG. 9 illustrates a perspective view of a second embodiment of a battery assembly that includes a mechanical switch according to the present invention.

FIG. 10A illustrates a perspective view of the top side of the battery box of the second embodiment of the battery assembly illustrated in FIG. 9.

FIG. 10B illustrates a bottom view of the battery box illustrated in FIG. 10A.

FIG. 11 illustrates a perspective view of a lever member of the second embodiment of the battery assembly illustrated in FIG. 9.

FIG. 12A illustrates a perspective view of the top of an insert member of the second embodiment of the battery assembly illustrated in FIG. 9.

FIG. 12B illustrates a perspective view of the bottom of the insert member illustrated in FIG. 12A.

FIG. 13 illustrates a perspective view of the interaction between the insert member illustrated in FIG. 12A with the lever member illustrated in FIG. 11.

FIG. 14 illustrates a view of the coupling of the lever member illustrated in FIG. 11 with the battery box illustrated in FIG. 10A.

FIG. 15A illustrates a perspective view of the top of battery box illustrated in FIG. 10A with the lever member illustrated in FIG. 11 and the insert member illustrated in FIG. 12A being coupled to the battery box.

FIG. 15B illustrates a bottom view of FIG. 15A showing the coupling of the battery box illustrated in FIG. 10A with the lever member illustrated in FIG. 11 and the insert member illustrated in FIG. 12A.

FIG. 15C illustrates a cross sectional view of coupling of the battery box illustrated in FIG. 10A with the lever member illustrated in FIG. 11 and the insert member illustrated in FIG. 12A.

Like reference numerals have been used to identify like elements throughout this disclosure.

### DETAILED DESCRIPTION OF THE INVENTION

The present invention disclosed herein is a battery assembly for an electronic device, where the battery assembly includes a battery box configured to house at least one battery and a mechanical switch. When at least one battery is stored within the battery box, the at least one battery, which includes a positive contact and a negative contact, is in abutment with positive and negative contacts disposed within the battery box. The negative contact disposed within the battery box may include a resilient member that is configured to bias the battery towards the positive contact and/or be compressed. Thus, the positive contact of the at least one battery is configured to abut the positive contact disposed within the battery box, and the negative contact of the at least one battery is configured to abut the negative contact disposed within the battery box.

The mechanical switch may include a wedge-like portion with a contact surface, and may be movably coupled to the battery box. The mechanical switch may be movable between a first, or “on”, position and a second, or “off”, position. When the mechanical switch is placed in the second position, the wedge-like portion, and specifically the contact surface of the wedge-like portion, contacts the positive contact of at least one battery. Because of the shape of the wedge-like portion, when the contact surface of the wedge-like portion of the mechanical switch abuts the positive contact of the at least one battery, the at least one battery is displaced or forced away from the positive contact disposed within the battery box. In other words, the positive contact of the at least one battery is urged out of abutment with the positive contact disposed within the battery box. Moreover, the resilient member of the negative contact disposed within the battery box is compressed to enable the positive contact of the at least one battery to be displaced away from the positive contact disposed within the battery box. Conversely, when the mechanical switch is placed in the first position, the wedge-like portion of the mechanical switch is no longer in contact with the positive contact of the at least one battery. Thus, the resilient member of the negative contact disposed within the battery box biases the at least one battery toward the positive contact disposed within the battery box so that the positive contact of the at least one battery abuts the positive contact disposed within the battery box.

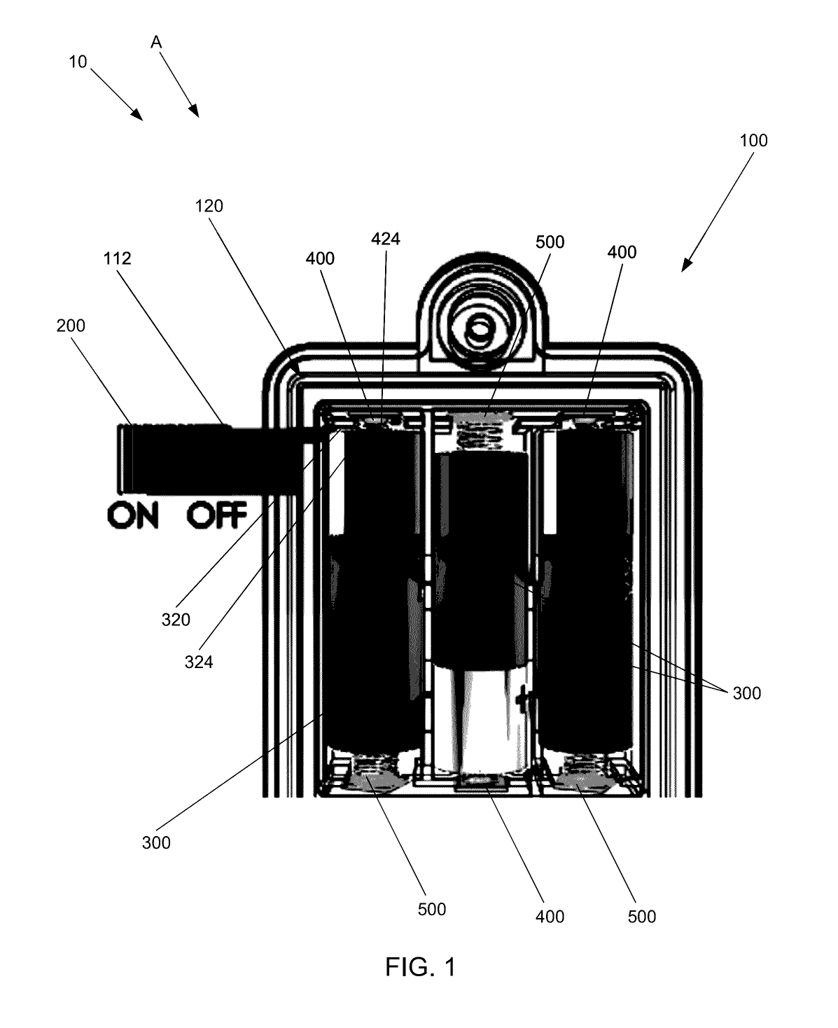

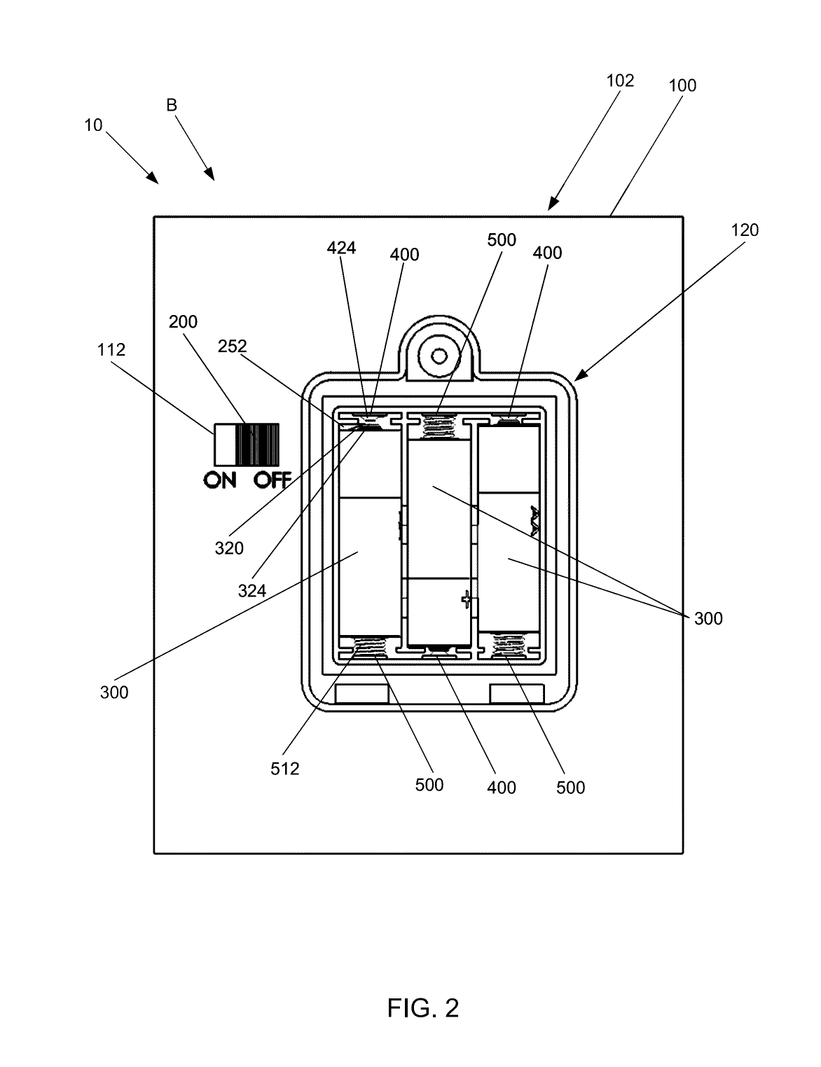

Turning to FIGS. 1-3, illustrated is a front view of a first embodiment of the battery assembly 10, in accordance with the present invention, to be used in an electronic device. The battery assembly 10 includes a battery box 100, a switch 200, a plurality of batteries 300, positive contacts 400, and negative contacts 500. The embodiment illustrated in FIGS. 1 and 2 include three batteries 300, but other embodiments of the battery assembly 10 may be configured to receive a different number of batteries 300.

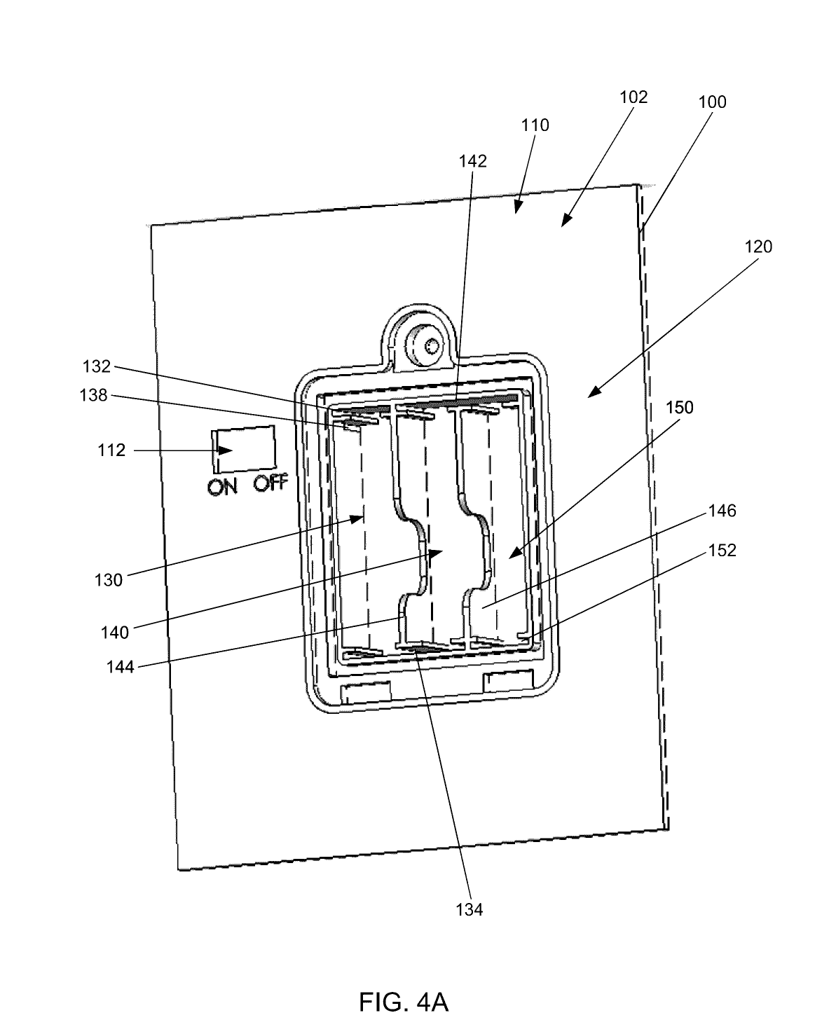

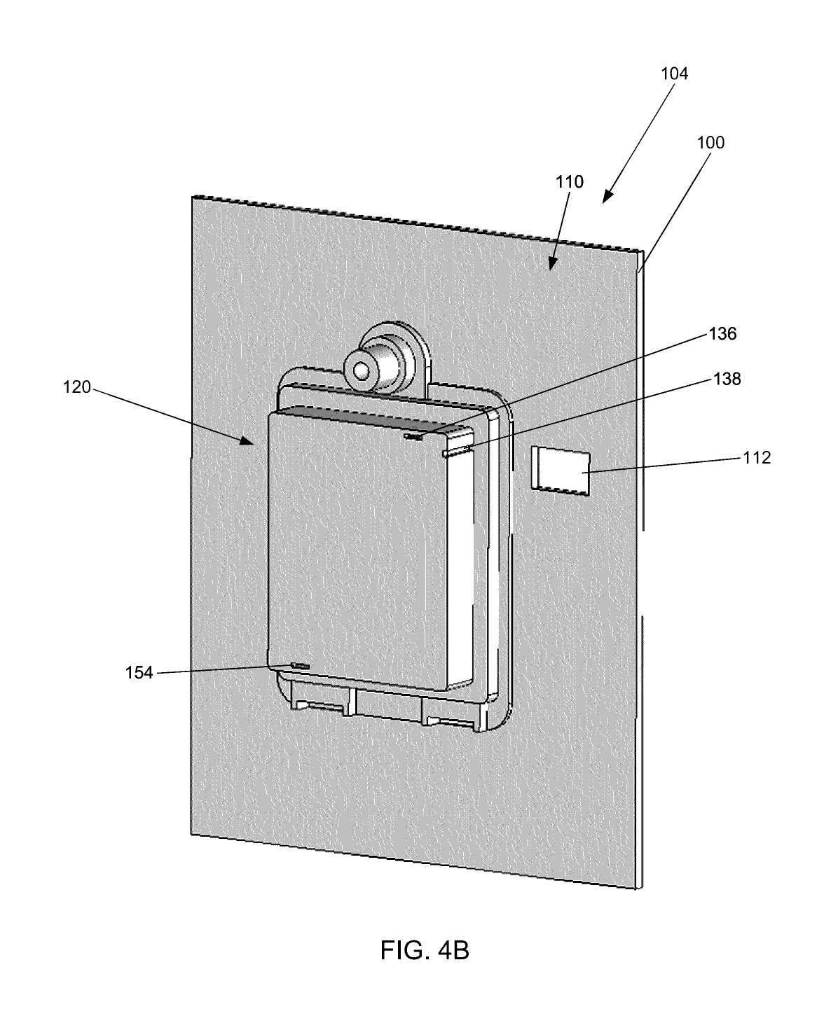

Turning to FIGS. 4A and 4B, illustrated are perspective views of the front and rear of a battery box 100 of the battery assembly 10. The battery box 100 includes a front surface 102, illustrated in FIG. 4A, and a rear surface 104, illustrated in FIG. 4B. The front surface 102 of the battery box 100 includes a cavity 120 that is surrounded by an outer wall 110. As illustrated in FIG. 4B, the cavity 120 extends outward from the rear surface 104 of the outer wall 110. The outer wall 110 contains an opening 112 that extends from the front surface 102 to the rear surface 104. As illustrated in FIG. 4A, the opening 112 is disposed to the left of the cavity 120.

The cavity 120 includes a first channel 130, a second channel 140, and a third channel 150, where each of the channels 130, 140, 150 is configured to receive a battery 300. The cavity 120 includes a first sidewall 144, which separates the first channel 130 from the second channel 140, and a second sidewall 146, which separates the second channel 140 from the third channel 150. The first cavity 130 includes an upper slot 132, where the upper slot 132 extends the width of the first channel 130. In addition, the first channel 130 and the second channel 140 share a lower slot 134, where the lower slot 134 is configured to extend the width of the first channel 130 and the second channel 140. The second channel 140 and the third channel 150 share an upper slot 142, where the upper slot 142 is configured to extend the width of the second channel 140 and the third channel 150. Finally, the third channel 150 includes a lower slot 152, where the lower slot 152 extends the width of only the third channel 150.

As best illustrated in FIGS. 1 and 2, the upper slot 132 of the first channel 130 is configured to receive a positive contact 400. The lower slot 134 shared by the first and second channels 130, 140 is configured to receive a negative contact 500 disposed proximate to the first channel 130 and a positive contact 400 disposed proximate to the second channel 140. Furthermore, the upper slot 142 shared by the second and third channels 140, 150 is configured to receive a negative contact 500 disposed proximate to the second channel 140 and a positive contact 400 disposed proximate to the third channel 150. The lower slot 152 of the third channel 150 is configured to receive a negative contact 500. As illustrated in FIGS. 1 and 2, the negative contacts 500 may extend, at least partially, into the channels 130, 140, 150.

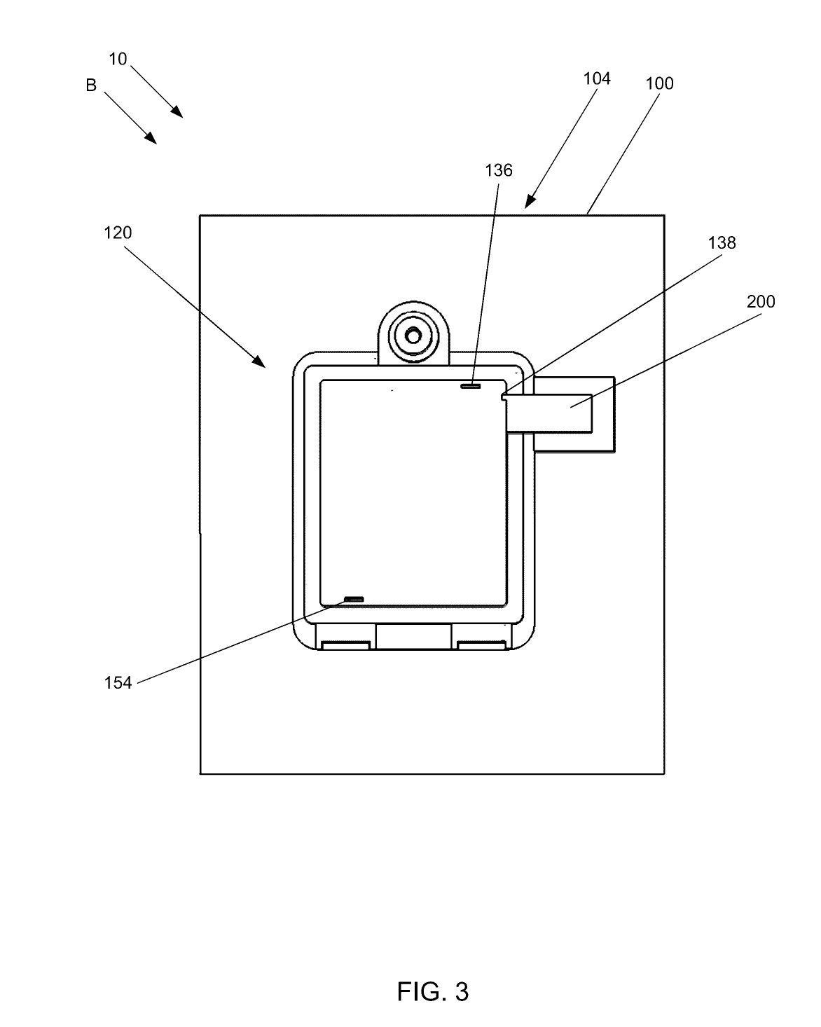

Returning to FIGS. 4A and 4B, the cavity 120 contains an aperture 138 proximate to the upper slot 132 of the first channel 130. The aperture 138 is positioned on the cavity 120 so that it faces towards the opening 112 disposed in the outer wall 110. Moreover, as illustrated in FIGS. 3 and 4B, the rear surface 104 of the cavity 120 includes a first slit 136 and a second slit 154. The first slit 136 is disposed proximate to the upper slot 132 of the first channel 130 and the second slit 154 is disposed proximate to the lower slot 152 of the third channel 150. The slits 136, 154 are configured to receive electrical contacts. The slit 136 is configured to receive an electrical contact that may be connected to the positive contact 400 disposed in the upper slot 132 of the first channel 130, while the slit 154 is configured to receive an electrical contact that may be connected to the negative contact 500 disposed in the lower slot 152 of the third channel 150.

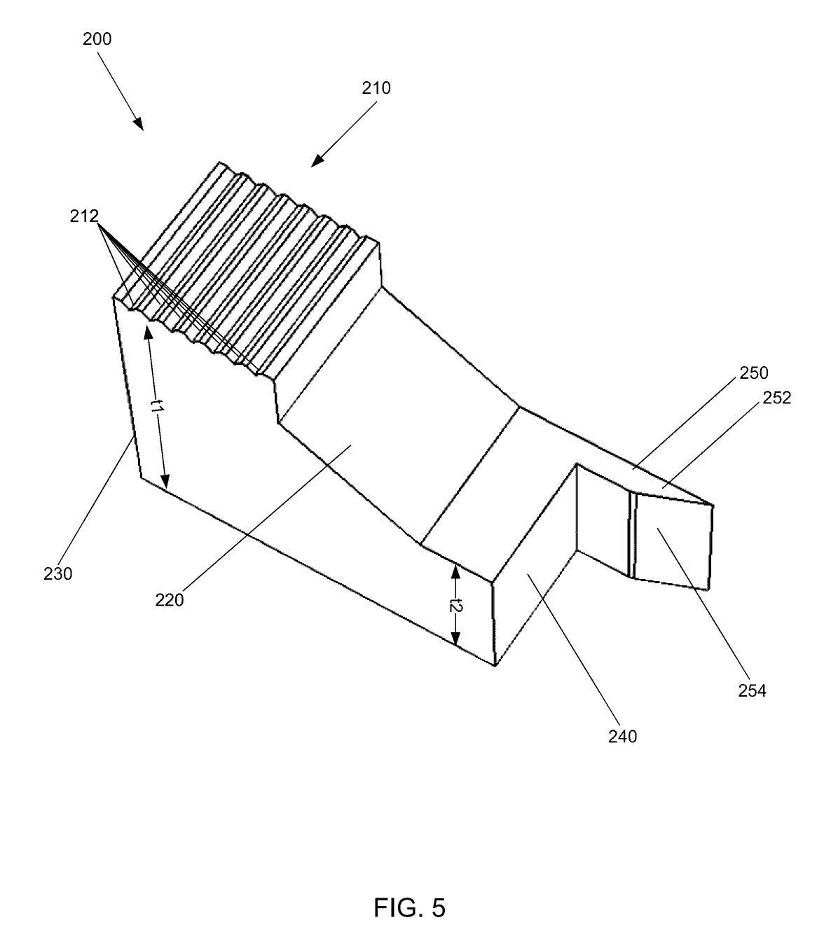

Turning to FIG. 5, illustrated is a perspective view of a switch 200 according to the first embodiment of the battery assembly 10. The switch 200 includes a first end 230 and a second end 240. The first end 230 contains a first thickness t1, while the second end 240 contains a second thickness t2. The thickness t1 of the switch 200 at the first end 230 is larger than the thickness t2 of the switch 200 at the second end 240. Disposed proximate to the first end 230 of the switch 200 is an outer surface 210. The outer surface 210 may include a plurality of grooves or serrations 212, which enables a user to easily manipulate and slide the switch 200. Disposed between the outer surface 210 and the second end 240 is a ramp section 220. As illustrated in FIG. 5, the ramp section 220 slopes downward toward the second end 240 from the outer surface 210. The switch 200 further includes a protrusion 250 that extends outwardly from the second end 240. The protrusion 250 is sized to fit within the aperture 138 of the cavity 120. The protrusion 250 further includes a wedge-like portion 252 with a contact surface 254.

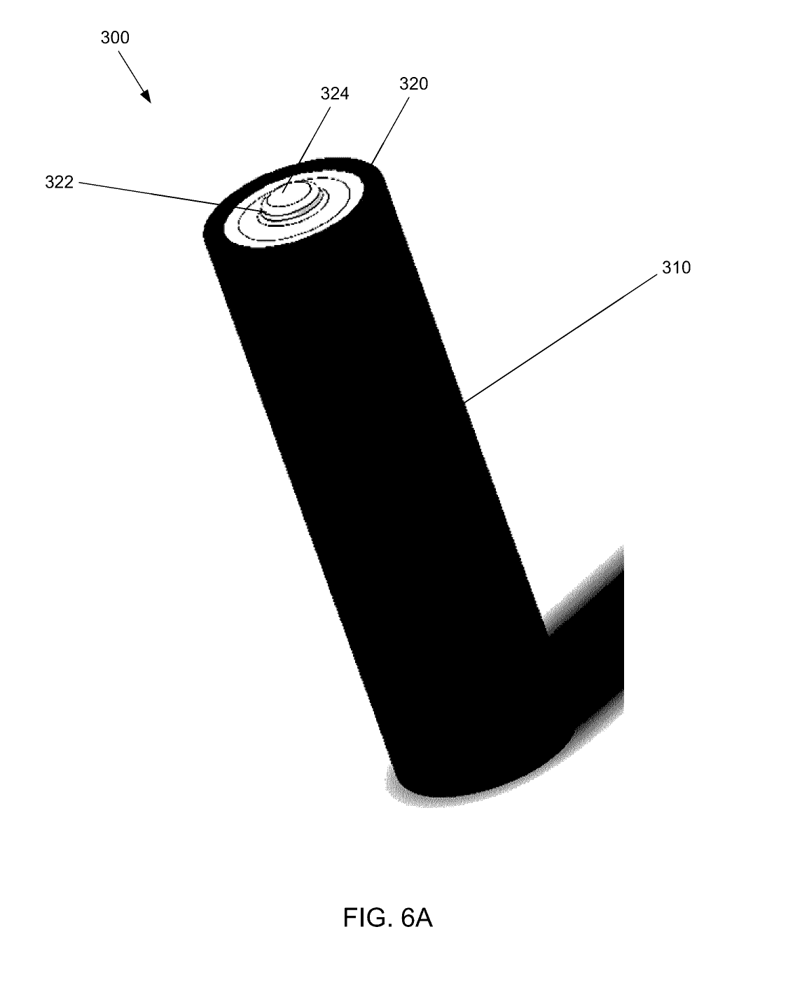

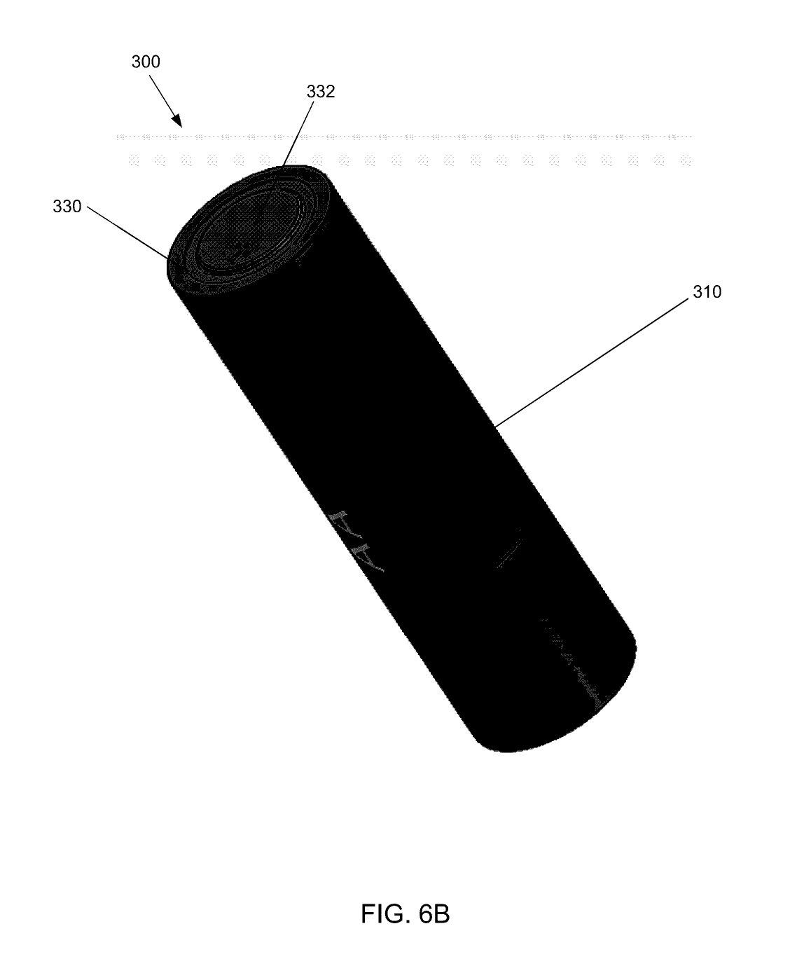

Illustrated in FIGS. 6A and 6B is a battery 300 that may be utilized with the battery assembly 10. The battery 300 may be any size battery, including batteries of the elongated type, including, but not limited to, D, C, AA, AAA, AAAA, and A23 type batteries. As illustrated in FIGS. 6A and 6B, the battery 300 is substantially cylindrical in shape with an outer surface 310. The battery 300 further includes a top end 320 and a bottom end 330. The top end 320 of the battery 300 includes a centrally located protrusion 322 that extends from the top end 320 of the battery 300. Furthermore, the protrusion 322 includes a positive contact (or “terminal”) 324. In addition, the bottom end 330 of the battery 300 includes a negative contact (or “terminal”) 332.

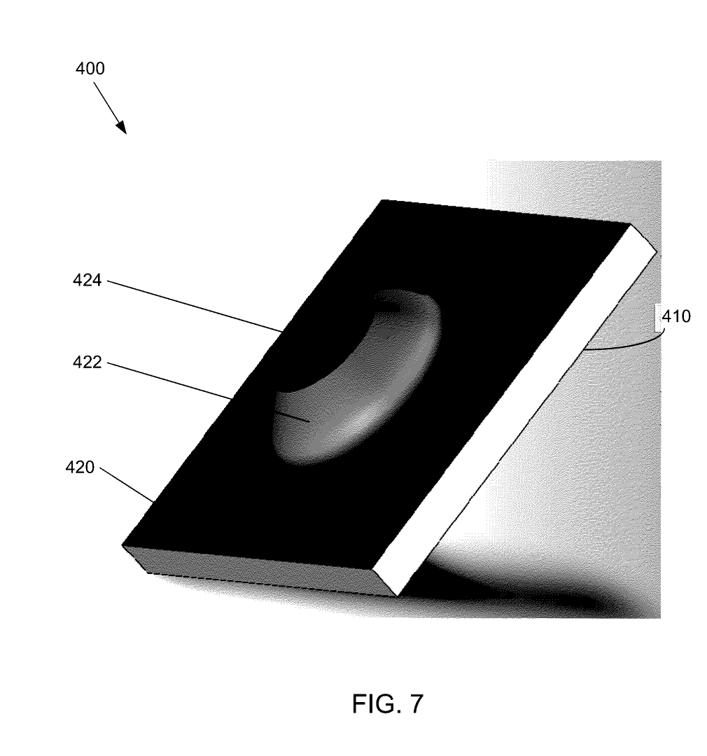

FIG. 7 illustrates a positive contact 400 that may be disposed within the battery box 100 of the battery assembly 10. The positive contact 400 contains a top surface 410 and a bottom surface 420, where the top surface 410 and the bottom surface 420 are oriented opposite of one another. The bottom surface 420 contains a centrally located extension 422. Moreover, disposed on the centrally located extension 422 is a contact surface 424.

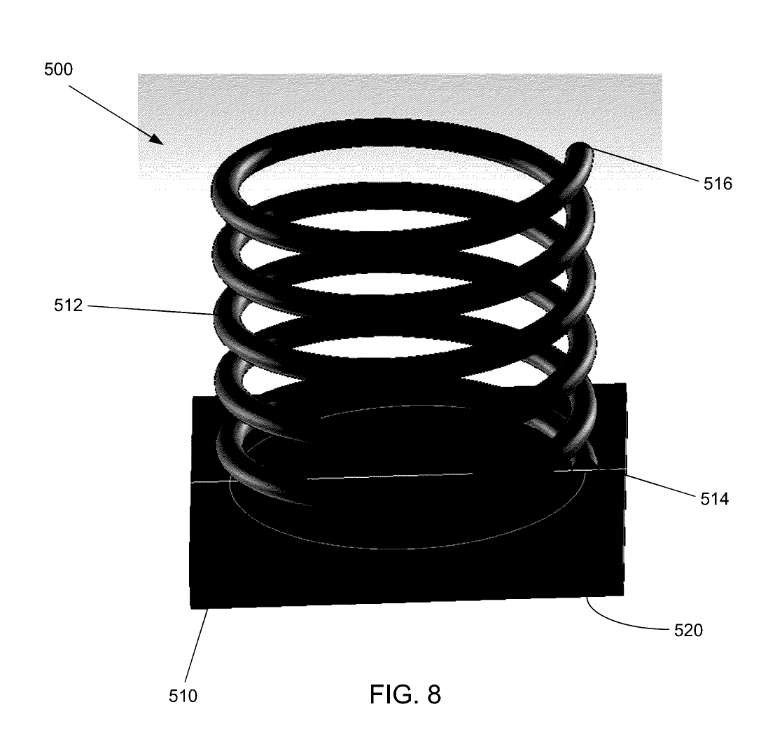

FIG. 8 illustrates a negative contact 500 that may be disposed within the battery box 100 of the battery assembly 10. The negative contact 500 contains a top surface 510 and a bottom surface 520, where the top surface 510 and the bottom surface 520 are oriented opposite of one another. As illustrated, the top surface 510 contains a resilient member 512. The resilient member 512 contains a first end 514 and a second end 516. The first end 514 of the resilient member 512 is disposed on the top surface 510 of the negative contact 500, while the second end 516 is disposed a distance above the top surface 510 of the negative contact 500. The resilient member 512 may be configured to be compressed, where the second end 516 is repositioned closer to the first end 514. Moreover, as previously stated, and as will be explained later, the resilient member 512 may be configured to bias the battery 300 into abutment with the positive contact 400 of the battery box 100.

Returning to FIGS. 1-3, as previously stated, the battery assembly 10 includes a battery box 100, a switch 200, a plurality of batteries 300, a plurality of positive contacts 400, and a plurality of negative contacts 500. Illustrated in FIG. 1, the battery assembly 10 is disposed in the “on”, or operational, configuration A, while illustrated in FIGS. 2 and 3, the battery assembly 10 is disposed in the “off”, or non-operational, configuration B. As illustrated in FIGS. 1 and 2, the switch 200 is at least partially disposed in the opening 112 on the outer wall 110 of the battery box 100 from the rear surface 104 of the outer wall 110. The switch 200 is at least partially disposed in the opening 112 so that the outer surface 210 of the switch 200 extends through the opening 112 on front surface 102 of the outer wall 110 and is exposed. In FIG. 1, the switch 200 is oriented proximate to the “on” indicia of the opening 112, which places the battery assembly 10 in the “on” configuration A. As illustrated in FIG. 1, when the battery assembly 10 is in the “on” configuration A, the wedge-like portion 252 of the switch 200 is disposed proximate to the aperture 138 of the cavity 120. However, the wedge-like portion 252 does not extend through the aperture 138 and into the first channel 130 of the cavity 120. Thus, as illustrated in FIG. 1, the resilient member 512 of the negative contact 500 disposed in the lower slot 134 biases the battery 300 in the first channel 130 upwards towards the positive contact 400. When biased by the resilient member 512 of the negative contact 500, the positive contact 324 on the top end 320 of the battery 300 abuts the contact surface 424 of the positive contact 400 that is disposed in the upper slot 132. Similarly, the resilient member 512 of the negative contact 500 disposed in the upper slot 142 biases the battery 300 in the second channel 140 downwards so the positive contact 324 on the top end 320 of the battery 300 abuts the contact surface 424 of the positive contact 400 that is disposed in the lower slot 134. In addition, the resilient member 512 of the negative contact 500 disposed in the lower slot 152 biases the battery 300 in the third channel 150 upwards so the positive contact 324 on the top end 320 of the battery 300 abuts the contact surface 424 of the positive contact 400 that is disposed in the upper slot 142. The positive and negative contacts 400, 500 disposed adjacent to one another in the lower slot 134 may be connected to one another and configured to pass an electrical current from one contact to another. The positive and negative contacts 400, 500 disposed adjacent to one another in the upper slot 142 may also be connected to one another and configured to pass an electrical current from one contact to another. Thus, the batteries 300 placed within the cavity 120 of the battery box 100 are connected in series with one another. When the battery assembly 10 in the “on” configuration A, the circuit of the batteries 300 is closed, and current is configured to flow through the battery box 100 via slit 154 and slit 136.

Conversely, as illustrated in FIGS. 2 and 3, the switch 200 is oriented proximate to the “off” indicia of the opening 112. When the switch 200 is slid over to the right portion of the opening 112 so that the outer surface 210 of the switch is located proximate to the “off” indicia, the battery assembly 10 is placed in the “off” configuration B. Sliding the switch 200 toward the “off” indicia causes the wedge-like protrusion 252 to extend through the aperture 138 of the cavity 120 and into the first channel 130. As best illustrated in FIG. 2, the wedge-like portion 252, and more specifically, the contact surface 254, extends into the first channel 130 proximate to the upper slot 132 and proximate to the top end 320 of the battery 300. Because of the shape of the wedge-like portion 252, when the switch 200 is slid toward the “off” indicia, the contact surface 254 contacts the top end 320 of the battery 300 and forces the battery 300 to slide down within the first channel 130 so that the positive contact 324 of the battery 300 no longer abuts the contact surface 424 of the positive contact 400 disposed in the upper slot 132. When the battery 300 is slid down the first channel 130, the resilient member 512 of the negative contact 500 is compressed. With the positive contact 324 of the battery 300 being separated from the contact surface 424 of the positive contact 400 disposed in the upper slot 132, the circuit of the batteries 300 is open, and thus current is not configured to flow out of the battery box 100 through slits 136/154. By opening the circuit when the battery assembly 10 is placed in the “off” configuration B, any electronic components that the battery assembly 10 is connected to will no longer be powered.

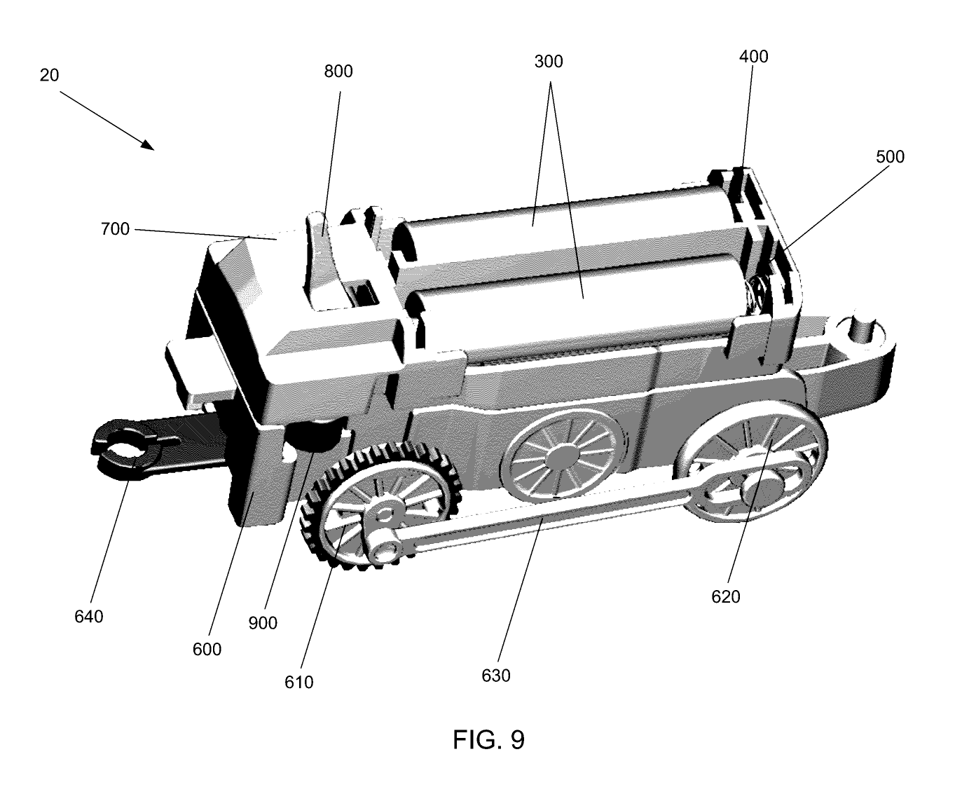

A second embodiment of a battery assembly 20 according to the present invention is illustrated in FIG. 9. The second embodiment of the battery assembly 20, as illustrated in FIG. 9, sits atop and powers a toy vehicle chassis 600. The chassis includes a set of rear wheels 610 and a set of front wheels 620, where the rear wheels 610 and the front wheels 620 are connected by a linkage bar 630. Moreover, extending rearwardly from the chassis 600 is a connector 640.

The second embodiment of the battery assembly 20 includes a battery box 700 that is configured to house two batteries 300, a plurality of positive contacts 400 (although only one is shown in FIG. 9), a plurality of negative contacts 500 (although only one is shown in FIG. 9), a lever 800 that extends from the battery box 700, and an insert member 900. The batteries 300 that are utilized with the second embodiment of the battery assembly 20 may be substantially similar to those batteries 300 discussed in relation with the first embodiment of the battery assembly 10. Similarly, the positive and negative contacts 400, 500 of the second embodiment of the battery assembly 20 may be substantially similar to those discussed in relation with the first embodiment of the battery assembly 10.

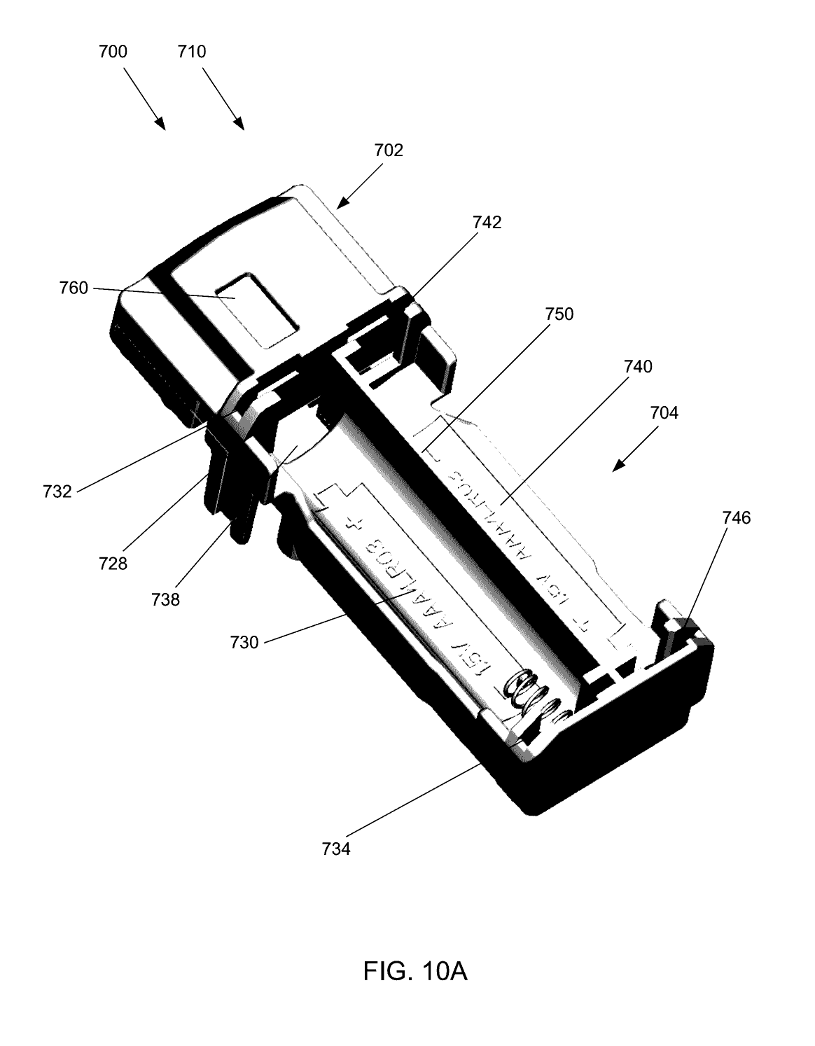

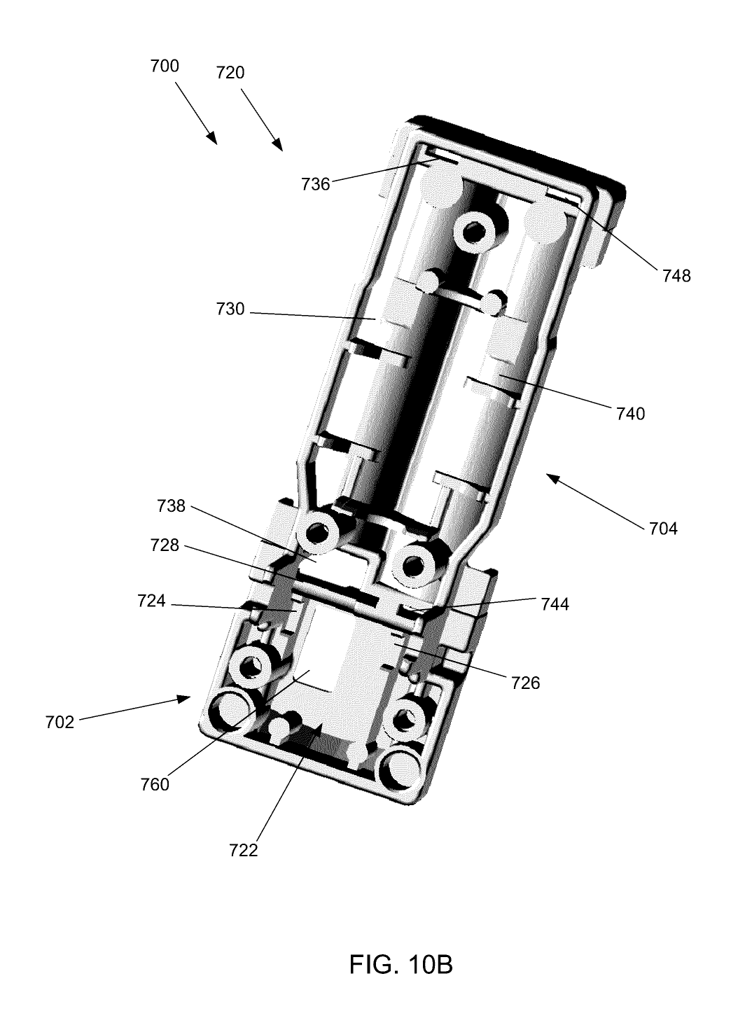

Turning to FIGS. 10A and 10B, illustrated is the battery box 700 of the second embodiment of the battery assembly 20. The battery box 700 includes a first portion 702, a second portion 704, a top surface 710, and a bottom surface 720. Disposed in the second portion 704 on the top surface 710 is a first channel 730 and a second channel 740, where the first and second channels 730, 740 are configured to receive and retain batteries 300. Moreover, the first and second channels 730, 740 are separated by a sidewall 750. The first channel 730 includes a first end slot 732 and a second end slot 734, which is disposed in the channel 730 opposite the first end slot 732. Similarly, the second channel 740 include a first end slot 742 and a second end slot 746, which is disposed in the channel 740 opposite the first end slot 742. However, the first channel 130 further includes an aperture 738 disposed proximate to the first end slot 732. As best illustrated in FIG. 10B, the battery box 700 includes a slit 736 disposed proximate to the second end slot 734 of the first channel 730. Moreover, the battery box 700 further includes a slit 744 disposed proximate to the first end slot 742 and a slit 748 disposed proximate to the second end slot 746 of the second channel 740. The slits 736, 744, 748 are configured to receive electrical contacts. The slit 736 may be configured to receive an electrical contact that may be connected to the negative contact 500 disposed in the second end slot 734 of the first channel 730. Furthermore, the slit 744 may be configured to receive an electrical contact that may be connected to the negative contact 500 disposed in the first end slot 742 of the second channel 740, and the slit 748 may be configured to receive an electrical contact that may be connected to the positive contact 400 disposed in the second end slot 746 of the second channel 740.

The first portion 702 of the battery box 700 includes an opening 760 that extends through the top surface 710 of the first portion 702 to the bottom surface 720 of the first portion 702. Moreover, the bottom surface 720 of the first portion 702 includes a cavity 722, which is best illustrated in FIG. 10B. The cavity 722 contains a first recess 724 disposed on one side of the cavity 722, and a second recess 726 disposed on the opposite side of the cavity 722 of the first recess 724. As illustrated in FIGS. 10A and 10B, a partition wall 728 divides the first portion 702 of the battery box 700 from the second portion 704 of the battery box 700.

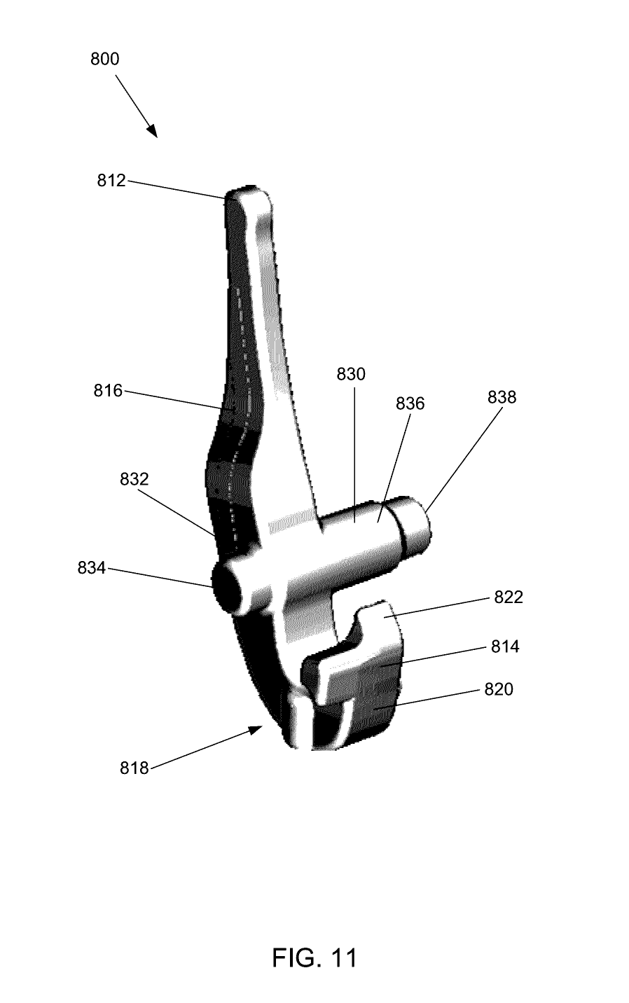

Turning to FIG. 11, illustrated is a perspective view of the switch member, or lever, 800. As illustrated the lever 800 contains a substantially “J” shape, where the lever 800 includes an elongated portion 816, a curved portion 818, and a wedge portion 820. The elongated portion 816 is longer in length than the wedge portion 820, and the curved portion 818 connects the elongated portion 816 to the wedge portion 820. Each of these portions 816, 818, 820 are connected to one another to form the substantially “J” shape of the lever 800. The lever 800 further includes a first end 812, which is formed as an end of the elongated portion 816, and a second end 814, which is formed as an end of the wedge portion 820. The wedge portion 820 further includes a contact surface 822 that is disposed proximate to the end 814 of the lever 800. FIG. 11 further illustrates an axle 830 disposed on the lever 800. The axle 830 is disposed on the elongated portion 816 proximate to the connection of the elongate portion 816 to the curved portion 818. The axle 830 includes a first extension 832 and a second extension 836. The first extension 832 includes a first end 834, while the second extension 836 includes a second end 838. The second extension 836 is longer in length than the first extension 832, which places the second end 838 farther from the elongate portion 816 than the first end 834.

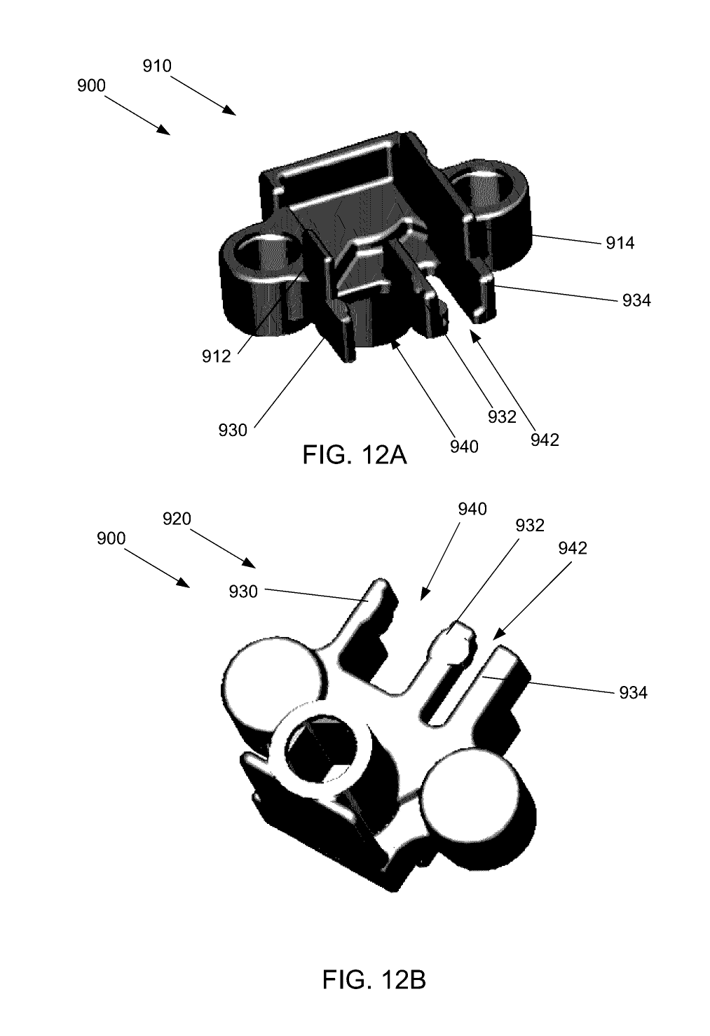

Turning to FIGS. 12A and 12B, illustrated is an insert member 900. The insert member 900 includes a top surface 910 and a bottom surface 920. Extending upwardly from the top surface 910 of the insert member 900 is a first sidewall 912 and a second sidewall 914. The first and second sidewalls 912, 914 are oriented opposite one another. Moreover, extending from the insert member is a first protrusion 930, a second protrusion 932, and a third protrusion 934. Each of these protrusions 930, 932, 934 are substantially equal in size and shape. The first and second protrusions 930, 932 are spaced from one another to form a first channel 940, while the second and third protrusions 932, 934 are spaced from one another to form a second channel 942. Because of the spacing of the protrusions 930, 932, 934, the first channel 940 is wider than the second channel 942. Other embodiments of the insert member 900 may only include two protrusions extending from the insert member 900, and thus, the insert member 900 may only contain one channel.

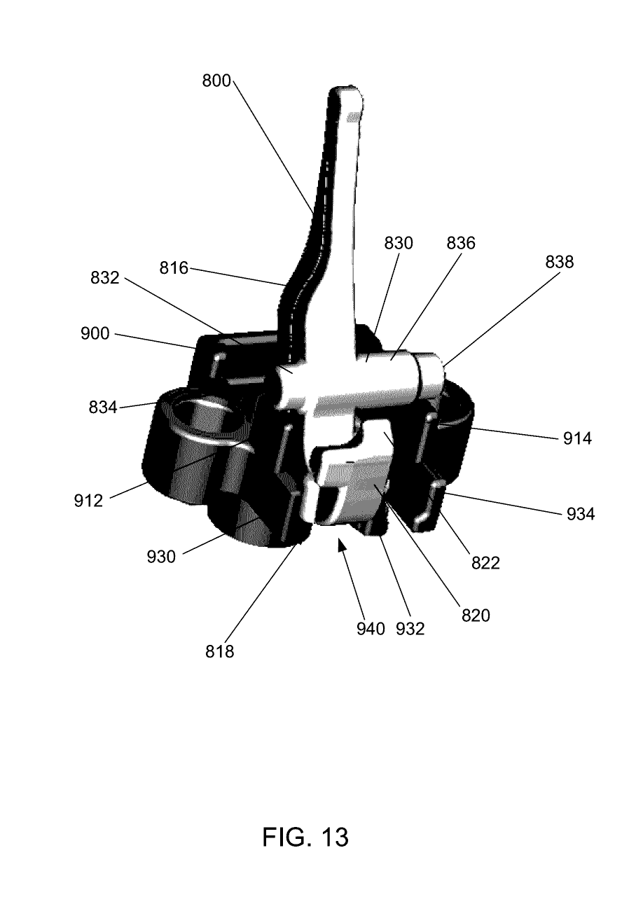

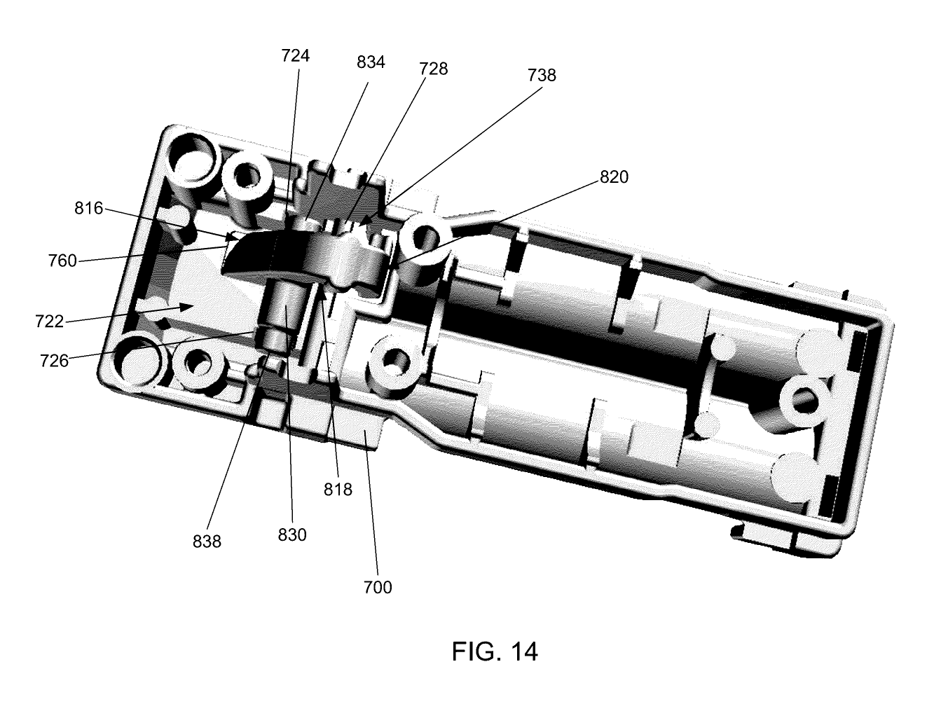

Illustrated in FIG. 13 is the interaction between the lever 800 and the insert 900. As illustrated, the first end 834 of the axle 830 is configured to sit atop the first sidewall 912 of the insert member 900, while the second end 838 of the axle 830 is configured to sit atop the second sidewall 914. Thus, the distance between the first end 834 and the second end 838 of the axle 830 is at least the same distance as between the first sidewall 912 and the second side wall 914. In other embodiments of the lever 800, the distance between the first and second ends 834, 838 of the axle 830 may be larger than the distance between the first and second sidewalls 912, 914 of the insert member 900. Furthermore, FIG. 13 illustrates that the curved portion 818 of the lever 800 is positioned between the first and second protrusions 930, 932, and disposed within the first channel 940. As also illustrated, the contact surface 822 of the wedge portion 820 of the lever 800 is extending outward and upward from the first channel 940 of the insert member 900.

Turning to FIG. 14, illustrated is a bottom view of the lever 800 inserted into the cavity 722 of the bottom surface 720 of the battery box 700. The elongate portion 816 of the lever 800 is inserted through the opening 760 of the battery box 700. Moreover, the first end 834 of the axle 830 is positioned within the first recess 724, and the second end 838 of the axle 830 is positioned within the second recess 726. The lever 800 is configured to at least partially rotate with respect to the battery box 700 and about the axle 830 when the axle 830 is positioned within the first and second recesses 724, 726. As further illustrated in FIG. 14, the curved portion 818 of the lever 800 is configured to curve around the partition wall 728 of the battery box 700. Thus, the wedge portion 820, as illustrated, extends upward and through the opening 738 of the battery box 700.

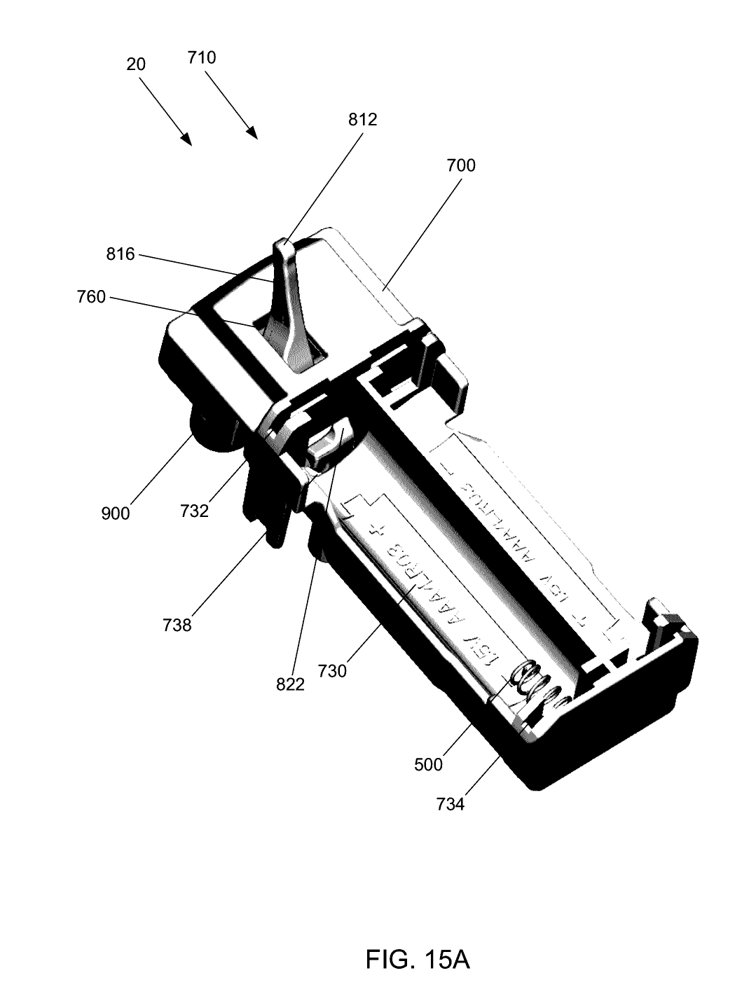

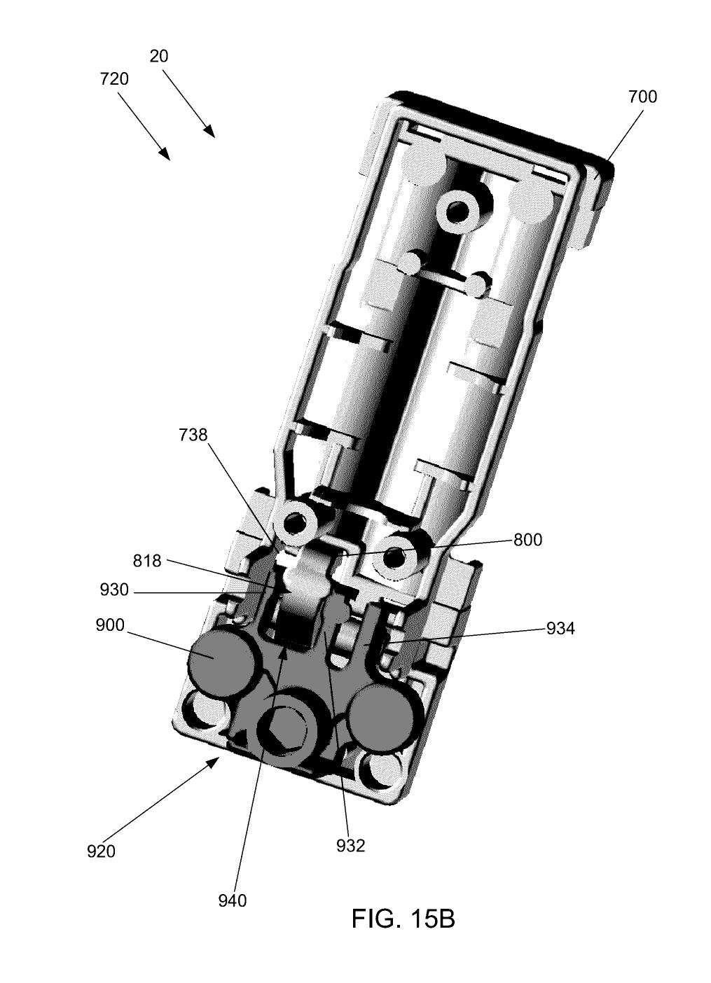

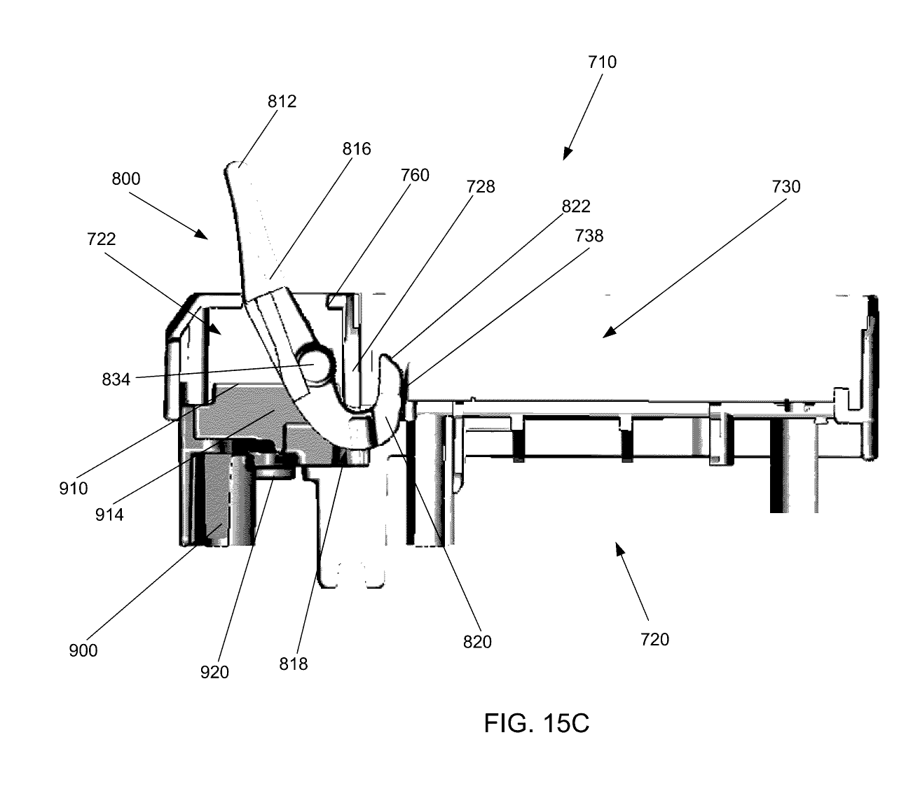

Turning to FIGS. 15A, 15B, and 15C, illustrated are views of the lever 800 and the insert 900 being coupled to the battery box 700. Illustrated in FIG. 15A is a perspective view of the top surface 710 of the battery box 700, illustrated in FIG. 15B is a view of the bottom surface 720 of the battery box 700, and illustrated in FIG. 15C is cross-sectional view of the battery box 700. As best illustrated in FIGS. 15A and 15C, the elongate portion 816 of the lever 800 extends upward through the opening 760 on the first portion 702 of the battery box 700. As illustrated, the first end 812 of the lever 800 extends upwardly from the top surface 710 of the battery box 700.

Moreover, as best illustrated in FIGS. 15B and 15C, the insert member 900, when coupled to the battery box 700, retains the lever 800 in the proper position within cavity 722. As illustrated, when the insert member 900 is coupled to the battery box 700, the top surface 910 of the insert member 900 is disposed within the cavity 722 of the first portion 702, while the bottom surface 920 of the insert member 900 is exposed below the bottom surface 720 of the battery box 700. Thus, as illustrated in FIG. 15C, the second sidewall 914 retains the end 838 of the axle 830 within the second recess 726, as previously explained with respect to FIG. 14. Similarly, while not illustrated, the first sidewall 912 positions the end 834 of the axle 830 within the first recess 724, as explained with respect to FIG. 14. As further illustrated in FIG. 15B, the curved portion 818 of the lever 800 is positioned within the first channel 940 formed by the first and second protrusions 930, 932 of the insert member 900, where the first and second protrusions 930, 932 serve as additional guide members when the lever 800 is moved between an “on” position and an “off” position.

As best illustrated in 15C, the curved portion 818 of the lever 800 is configured to curve around the bottom of the partition wall 728. Because the curved portion 818 of the lever 800 curves around the partition wall 728, the wedge portion 820 of the lever 800 is positioned within the opening 738 of the first channel 730. As further illustrated in FIGS. 15A and 15C, the contact surface 822 of the wedge portion 820 of the lever 800 is positioned within the first channel 730 proximate to the first end slot 732.

Continuing with FIGS. 15A, 15B, and 15C, while not illustrated, when a battery 300 is inserted into the first channel 730, the positive contact 324 of the battery 300 is disposed proximate to the first end slot 732 and abutting a positive contact 400 disposed within the first end slot 732. Moreover, the negative contact 332 of the battery 300 is disposed proximate to the second end slot 734 and abutting the resilient member 512 of the negative contact 500 disposed within the second end slot 734. The lever 800 is configured to pivot between an “on” configuration and an “off” configuration. As illustrated, in FIGS. 15A, 15B, and 15C, the lever 800 is positioned in the “off” configuration. In the “off” configuration, the contact surface 822 of the wedge portion 820 of the lever 800 is disposed within the first channel proximate to the first end slot 732, and thus, disposed proximate to the positive contact 400 disposed within the first end slot 732. Because of the shape of the wedge-like portion 820, when the lever 800 is positioned in the “off” configuration, the contact surface 822 contacts the top end 320 of the battery 300 and forces the battery 300 to slide within the first channel 730 so that the positive contact 324 of the battery 300 no longer abuts the contact surface 424 of the positive contact 400 disposed in the first end slot 732. Similar to that of the first embodiment of the battery assembly 10, when the battery 300 is slid down the first channel 730 of the battery box 700 of the second embodiment of the battery assembly 20, the resilient member 512 of the negative contact 500 disposed within the second end slot 734 is further compressed. With the positive contact 324 of the battery 300 being separated from the contact surface 424 of the positive contact 400 disposed in the upper slot 132, the circuit of the batteries 300 is open, and thus current is not configured to flow out of the battery box 700 to power the toy vehicle chassis 600.

When the first end 812 of the lever 800 is pivoted toward the first and second channels 730, 740 of the second portion 704 of the battery box 700, the second embodiment of the battery assembly 20 is disposed in the “on” configuration. When the second embodiment of the battery assembly 20 is in the “on” configuration, the wedge portion 820 of the lever 800 is disposed proximate to the opening 738 of the first channel 730, but the wedge portion 820 does not extend through the opening 738 and into the first channel 730. Thus, the resilient member 512 of the negative contact 500 disposed in the second end slot 734 biases the battery 300 towards the first end slot 732 of the first channel 730 so the positive contact 324 on the top end 320 of the battery 300 again abuts the contact surface 424 of the positive contact 400 that is disposed in the first end slot 732. Thus, when the second embodiment of the battery assembly 20 is in the “on” configuration, the circuit of the batteries 300 is closed, and current is configured to flow from the battery box 700 to the toy vehicle chassis 600 to power the wheels 610, 620.

In alternative embodiment, the battery assembly, as previously described, includes mechanical switch with a first end and a second end, where an electrical contact may be included on the second end of the mechanical switch rather than disposed within the housing. According to the alternative embodiment, the battery assembly may include a battery box configured to house at least one battery. Moreover, because an electrical contact may be included on the second end of the switch, the battery box may only include one electrical contact. Thus, when at least one battery is stored within the battery box, the at least one battery, which includes a positive contact and a negative contact, is in abutment with the one electrical contact disposed within the battery box. Similar to the previous embodiments, the unitary mechanical switch is movable between a first, or “on”, position and a second, or “off”, position. When the switch is in the first position, the second end of the switch and the electrical contact included thereon may be disposed outside of the channel. Thus, in the first position, the electrical contact is not in abutment with the at least one battery disposed within the battery box, and the electrical circuit is open. It then follows that when the mechanical switch is in the first position, current does not flow out of the battery box, and power is not supplied from the battery to the device in which the battery assembly is coupled. When the switch is in the second position, the second end of the switch and the electrical contact included thereon may be at least partially disposed within the battery box and in abutment with the at least one battery disposed within the battery box. Thus, when the switch is in the second position, the electrical circuit is closed, and current flows out of the battery box supplying power from the battery to the device in which the battery assembly is coupled. According to this alternative embodiment, the electrical contact included on the second end of the switch may be either a positive electrical contact or a negative electrical contact. The electrical contact included on the second end of the switch may be permanently or fixedly disposed on the second end of the switch, and may move in unison with the second end of the switch.

As mentioned above, although the phrases “positive contact” and “negative contact” are used throughout this disclosure, the invention disclosed herein may be applied to either the positive contact or the negative contact without departing from the scope and spirit of the invention.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A battery assembly comprising:
a housing configured to receive at least one battery as part of an electrical circuit, the at least one battery including terminals for the transmission of electrical energy; and
a switch including a first end and a second end, the switch being movably coupled to the housing between a first position and a second position, wherein in the first position, the circuit is open and the second end of the switch is not in contact with at least one of the battery terminals, and in the second position, the second end of the switch is in contact with the at least one of the battery terminals and the circuit is closed.

2. The battery assembly of claim 1, further comprising:
a first electrical contact disposed on the second end of the switch.

3. The battery assembly of claim 2, further comprising:
a second electrical contact disposed within the housing.

4. The battery assembly of claim 2, wherein movement of the switch into the second position places the first electrical contact into abutment with the at least one battery terminal.

5. The battery assembly of claim 3, wherein the first electrical contact is a positive electrical contact and the second electrical contact is a negative electrical contact with a resilient member.

6. The battery assembly of claim 1, wherein the housing is electronically coupled to an electronic component and the electronic component is powered by the at least one battery when the switch is in the second position, and is electrically disconnected from the at least one battery when the switch is in the first position.

7. An apparatus comprising:
a housing configured to receive at least one battery, the housing including a first end, a second end;
at least one positive electrical contact disposed in the housing proximate the first end;
at least one negative electrical contact disposed in the housing proximate the second end; and
a switch having a first end and a second end, the switch being pivotally coupled to the housing and configured to pivot between a first position and a second position, wherein pivoting the switch into the second position extends the second end of the switch into the housing proximate to move the at least one battery out of contact with either the at least one positive electrical contact or the at least one negative electrical contact.

8. The apparatus of claim 7, wherein the housing further includes a first portion and a second portion, the switch being pivotally coupled to the first portion, and the at least one battery being received in the second portion.

9. The apparatus of claim 8, wherein the housing further includes a partition that separates the first portion of the housing from the second portion of the housing.

10. The apparatus of claim 9, wherein the switch includes an elongate portion, a curved portion, and a wedge portion.

11. The apparatus of claim 10, wherein the curved portion of the switch is configured to curve around the partition of the housing.

12. The apparatus of claim 11, wherein the wedge portion extends into the housing proximate to the at least one positive electrical contact.

13. The apparatus of claim 10, wherein the elongate portion of the switch extends substantially outwardly from the first portion of the housing.

14. A apparatus comprising:
a housing configured to receive at least one battery, the housing including a first end, a second end;
at least one positive electrical contact disposed in the housing proximate the first end;
at least one negative electrical contact disposed in the housing proximate the second end, the negative contact including a resilient member configured to bias the at least one battery into abutment with the at least one positive contact; and
a switch having a first end and a second end, the switch being slidably coupled to the housing and configured to slide between a first position and a second position, wherein sliding the switch into the second position extends the second end of the switch into the housing to move the at least one battery out of contact with either the at least one positive electrical contact or the at least one negative electrical contact.

15. The apparatus of claim 14, wherein the housing further includes a first channel with a first positive electrical contact and a first negative electrical contact, a second channel with a second positive electrical contact and a second negative electrical contact, and each of the channels is configured to simultaneously receive one battery.

16. The apparatus of claim 15, wherein the batteries are connected in series.

17. The apparatus of claim 16, wherein the housing further includes an opening disposed in the first channel proximate to the first positive electrical contact.

18. The apparatus of claim 17, wherein when the switch is in the second position, the second end of the switch is configured to extend into the first channel proximate to the first positive electrical contact to separate the battery received in the first channel from the first positive electrical contact.

19. The apparatus of claim 15, wherein the housing further includes a plurality of sidewalls that separate the battery channels.

20. The apparatus of claim 14, wherein the switch includes an outer surface disposed proximate to the first end of the switch, the outer surface being configured to at least partially extend outward from the housing.
